(19) United States
(12) Patent Application Publication
(10) Pub. No.: US 2015/0310385 A1
(43) Pub. Date: Oct. 29, 2015

(54) System for Managing Expiration-Dated Products

(71) Applicant: E Smart Labels LLC, Bowling Green, OH (US)

(72) Inventors: Christopher Harold King, Fayetteville, GA (US); Brian K. Artz, Maumee, OH (US)

(73) Assignee: E Smart Labels LLC, Bowling Green, OH (US)

(21) Appl. No.: 14/694,104

(22) Filed: Apr. 23, 2015

Related U.S. Application Data
(60) Provisional application No. 61/985,048, filed on Apr. 28, 2014.

(51) Int. Cl. G06Q 10/08

(52) U.S. Cl. CPC G06Q 10/087

(57) ABSTRACT

A system for managing expiration-dated products that includes, among other things, a computer, an electronic label in communication with the computer, and a program product comprising machine-readable program code for causing, when executed, the computer to transmit a data set containing expiration date information to the electronic label.

### CROSS-REFERENCE TO RELATED APPLICATION

This relates to and claims the benefit of U.S. Provisional Patent Application No. 61/985,048, filed on Apr. 28, 2014, which is incorporated herein by reference in its entirety.

### TECHNICAL FIELD

The invention relates to inventory control systems and, more particularly, systems for managing expiration-dated products.

### BACKGROUND OF THE INVENTION

Current methods of managing expiration-dated products, e.g., just-in-time manufactured (e.g., fresh prepared foods in restaurants) and perishable packaged manufactured ingredients/products require the user/consumer to apply pre-printed or blank (to facilitate handwritten information) single-use adhesive materials (e.g., stickers) to the containers to facilitate notice of date of expiration. In many situations, the safety of the just-in-time manufactured or opened perishable packaged ingredient and product is defined by local and state law wherein the product cannot be portioned and then sold to consumers past a certain defined time period (e.g., seven days after preparation of a ready to eat food in retail food service establishments in the United States or after a “use by” date has occurred after a consumer/user has opened a packaged ingredient or product as defined by the ingredient/product manufacturer (including food, chemicals, cosmetics, pharmaceuticals, laboratory reagents, vaccines, etc.)).

Typically, date marking adhesives (stickers) are passive devices that must be replaced each time the storage container is reused (e.g., when a restaurant reusable food container is washed, rinsed, and sanitized after the food in it is used or discarded). Likewise, preprinted labels with expiration date information do not actively alert users to when the product will and has expired upon opening (normally based on manufacturer recommendations and/or state and federal regulatory requirements). The information recorded on these adhesive materials often times becomes illegible due to the storage conditions that effect the inks, which can result in the information not being used properly or not used effectively. Further, remaining adhesives from the labels often become a source for contamination when left on reusable food containers. These situations can increase food safety risk to the consumer. More importantly, the safety, quality and thus value of all perishable just-in-time manufactured products and newly opened perishable packaged ingredients and products can be compromised when used beyond the expiration date. This is because there is no efficient means to track and make notice to users which just-in-time manufactured products and opened perishable packages of ingredients and products should be used first before their expiration date occurs, nor is there a current means to provide users/consumers with a caution as to when a perishable product no longer retains its safety/quality or value.

As can be seen, there is a need for an electronic system for managing expiration-dated products as well as for notifying users of the expiration dates for legal, safety, value, quality, and inventory purposes.

### BRIEF SUMMARY OF THE INVENTION

In summary, the invention is a system for managing expiration-dated products. In an embodiment, the system may include, among other things, a computer, an electronic label in communication with the computer, and a program product comprising machine-readable program code for causing, when executed, the computer to transmit a data set containing expiration date information to the electronic label.

### BRIEF DESCRIPTION OF THE DRAWINGS

FIG. 1 is a schematic view of an embodiment of the system for managing expiration-dated products according to the invention.

FIG. 2 is a schematic view of an embodiment of the system for managing expiration-dated products according to the invention.

FIG. 3 is a schematic view of an embodiment of the system for managing expiration-dated products according to the invention.

FIG. 4 is a schematic view of the system shown in FIG. 3.

FIG. 5 is a schematic view of the system shown in FIG. 3.

FIG. 6 is a schematic view of an embodiment of the system for managing expiration-dated products according to the invention.

FIG. 7 is a schematic view of an embodiment of a label of the system for managing expiration-dated products according to the invention.

FIG. 8 is a schematic view of an embodiment of a label of the system for managing expiration-dated products according to the invention.

FIG. 9 is a schematic view of an embodiment of a label of the system for managing expiration-dated products according to the invention.

FIG. 10 is a schematic view of an embodiment of a menu editor of the system for managing expiration-dated products according to the invention.

FIG. 11 is a schematic view of an embodiment of a user interface of the system for managing expiration-dated products according to the invention.

FIG. 12 is a schematic view of an embodiment of a print menu of the system for managing expiration-dated products according to the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the invention provides a management system. The management system may include at least one computer with a user interface. The computer may have a program product including a machine-readable program code for causing, when executed, the computer to perform steps. The management system may include reusable, water proof, heat/cold resistant, relatively easy to use plurality of e-addressable displays configured to receive a plurality of mutable data sets, for example, an expiration date. The program product may manage the plurality of data sets associated with at least one e-addressable display affixed to a product container at the point of just-in-time manufacture or placed at the time of manufacture of perishable packaged ingredients/products.

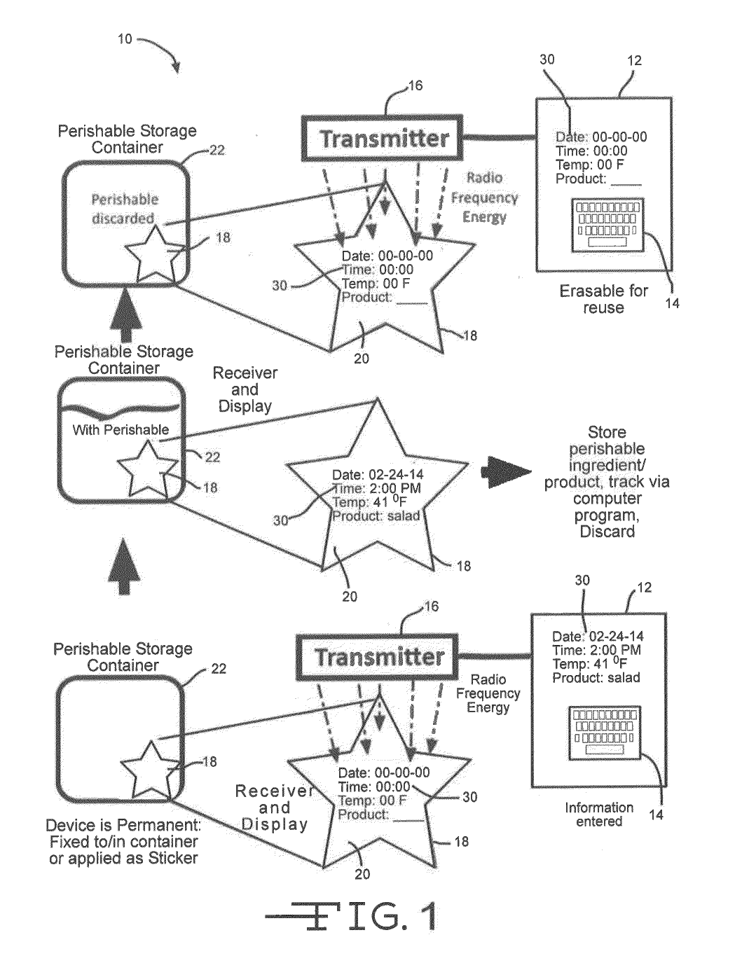

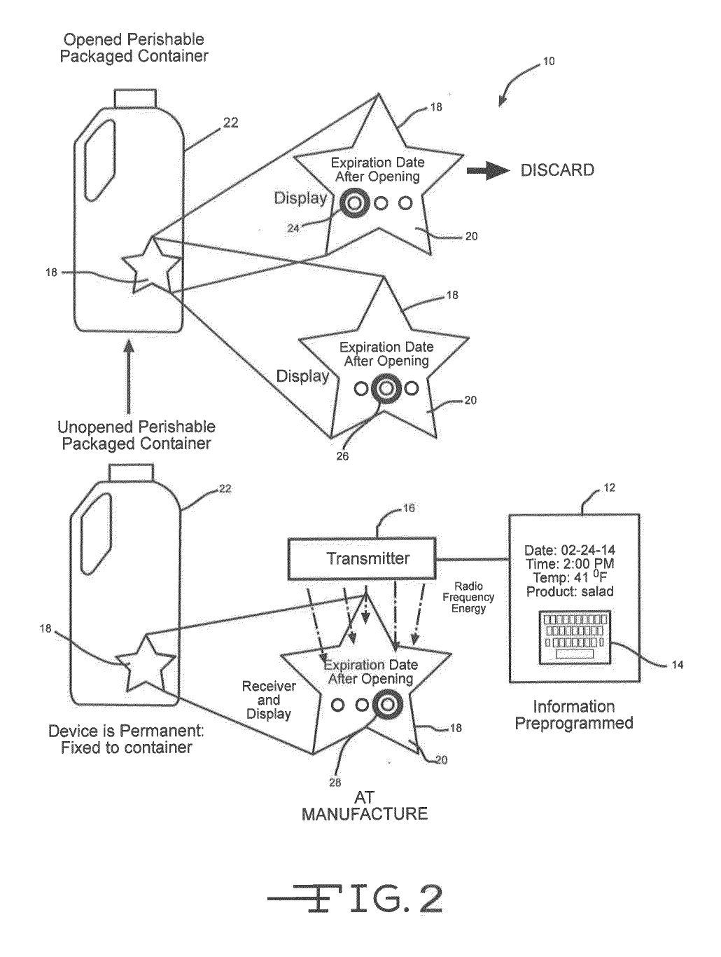

Referring now to FIGS. 1 and 2, the invention may include a management system 10. The management system 10 may include at least one computer 12 with a user interface 14. The computer 12 may include at least one processing unit and a form of memory including, but not limited to, a desktop, laptop, and smart device, such as, a tablet and smart phone. The computer 12 includes a program product including a machine-readable program code for causing, when executed, the computer 12 to perform steps. The program product may include software which may either be loaded onto the computer 12 or accessed by the computer 12. The loaded software may include an application on a smart device. The software may be accessed by the computer 12 using a web browser. The computer 12 may access the software via the web browser using the Internet, extranet, intranet, host server, Internet cloud and the like. The computer 12 may include a transmitter 16, for example, but not limited to a radio-frequency transmitter for transmitting information and/or data to a plurality of electronic labels such as e-addressable displays 18.

The management system 10 may include the plurality of e-addressable displays 18. The plurality of e-addressable displays 18 may be a thin film having an adhesive side and a display side 20. The display side 20 may include display technologies designed to display mutable information transmitted from the computer 12 and/or program product, such as e-paper, electronic ink, electrophoretic deposition processes and the like. The adhesive side may be adapted to irremovably adhere to a plurality of product containers 22 and the materials they are typical comprised of, such as plastic or the like. The adhesive side may also be adapted to include a snap, pin, clip or the like to attach to the perishable ingredient/product containers 22. In certain embodiments, the adhesive side may be manufactured permanently on all new perishable ingredient/product storage containers 22 or affixed as a sticker by a user to reusable perishable ingredient/product containers 22.

As a result the plurality of e-addressable displays 18 may be reusable, for example on reusable retail food service food/chemical containers 22, by re-transmission to erase and display new information to the display side 20. In certain embodiments, the plurality of e-addressable displays 18 may be reused by re-transmission of radio-frequency energy or permanently programmed for single use with an integrated electronic timer and an autonomous battery.

The program product may help a user manage product waste, safety/efficacy/quality of ingredients/products, and regulatory compliance to such. The user (e.g., a manufacturing company) may also preprogram expiration dates to the plurality of e-addressable displays 18 that may include an electronic timer so as to indicate through the display side 20, for example, the “use by” expiration date. In certain embodiments, such as the one shown in FIG. 2, the display side 20 may be a red display 24 (stop using), a yellow display 26 (about to expire) or a green display 28 (safe to use) occurring after a perishable packaged ingredient/product is opened by a consumer.

A method of using the invention will now be described. The management system 10 disclosed above may be provided. A user may place at least one of e-addressable display 18 on at least one storage container 22. The at least one e-addressable display 18 may then receive a data set 30 that the user transmits from the computer 12. The data set 30 may include but is not limited to an expiration date. Then the at least one e-addressable display 18 may electronically display the data set 30 on the display side 20. The data set 30 may also be captured by the program product for associating the data set 30 with the at least one storage container 22. The program product may be configured to store the data set 30, manage a plurality of data sets 30 and/or notify the user regarding the data set 30 at a predetermined time.

In certain embodiments, the user inputs at least one data set 30 into the computer 12 to enable the user to enter data such as date of expiration and product name specific to an ingredient or product. This could include a list of all ingredients and products and important information about proper use so the program product quickly enables the user to scroll and pick (click on) the items on the user interface 14 so that the user may date mark. The at least one data set 30 may be transmitted to the transmitter 16 to the at least one e-addressable display 18, which may use radio-frequency energy to induce (activate) updates (e.g., when the storage container 22, to which the e-addressable display 18 is affixed, is washed and reused to prepare fresh product) to each e-addressable display 18 regarding date of expiration information and product name. The program product may enable tracking of a plurality of data sets 30 to each e-addressable display 18. The program product may provide utilities to manage ingredient/product use including alerts to the user to pending product expiration dates of individual containers 22 by accessing the data set 30 associated to the affixed e-addressable display 18. Each e-addressable display 18 may also display indicators for which product to use first (e.g., red, yellow or green) so users may quickly select those products with shorter shelf-life reducing waste.

In certain embodiments, if date of expiration may be defined, then based on current date the e-addressable display 18 may display and/or report pending and final expiration end point via numerical display and/or indicators of such.

In certain embodiments, the e-addressable display 18 may contain an electronic timer that will induce a preprogrammed change in the display based on the current date and defined expiration date entered while in use on the storage container with the perishable ingredient/product. For example, a green color change is displayed at first transmission (if before the expiration date) to indicate that the ingredient or product can be continually used, a yellow color change is displayed to indicate that it is close to expiration and thus should be used soon, or a red color indicator occurs to indicate to the user to stop using the ingredient or product (for when the product reaches its expiration date and then when it has expired and no longer safe or with efficacy or quality for use). In an embodiment, a black-and-white display showing visual elapsed time such as a clock icon, or such wording as “use first,” indicates that the ingredients or product can be continually used until the expired date, or visual elapsed time such as a clock icon shows the allotted time has been expended. The user then manages perishable ingredients/products easily by ensuring no display device on stored perishables reaches red, the black-and-white expiration date, or the visual display of elapsed time indicating that the allotted time has been expended (by using up the product before more is prepared); for example to define first use of perishable just-in-time manufactured food products stored in containers within, e.g., a restaurant walk-in cooler that will expire within 7 days (according to regulatory requirements) to avoid food waste, ensure regulatory compliance and food safety, and determine when new product should be prepared.

In certain embodiments, the management system 10 may be used in retail food service so as to reduce food loss (and cost) and improved food quality in restaurants (showing which products to use first using First-in-First-Out (FIFO) rules) as well as increasing value (reducing waste) for other users/consumers of perishable packaged ingredients and products.

In an embodiment, the program product may be pre-programmed by a manufacturer of packaged perishable ingredients/products for one-time use (to ensure consumer safety) in that the electronic timer within the e-addressable display 18 functions to alert the user to proper use and when the product expires based on manufacturer defined “upon opening” expiration dates. For example, when a user purchases the product and it is opened by the user (e.g., a consumer), it is activated and displays alerts (e.g., green to indicate that it can be continually used, yellow to indicate that it is close to its expiration date so use soon, or red to indicate to stop using) for when the product will reach its expiration date.

In certain embodiments, the management system 10 may be used with smart Internet based systems connected to home storage devices (e.g., refrigerators) to report to consumers which products are expired and no longer safe or edible and when to reorder those products (or automatic reorder linked to a service). Alternatively, the management system 10 may be used with other technology to improve logistics of perishable ingredient used to manufacture food (e.g. during food manufacturing to indicate which ingredients should be used before they expire) or for storage and distribution of food logistics.

A method of making an electronic label such as an e-addressable display 18 according to the invention may include the following: First, an individual may produce the e-addressable display 18 that contains an electrically addressable bistable electrically active ink display with an adhesive that can be mass produced via electronic paper printing that includes (a) electrically active ink contained in a thin film semi-flexible substrate such as plastic-based liquid crystal display-like twisted nematic, supertwisted nematic, polymer dispersed liquid crystal, or bistable cholesteric liquid crystals; (b) the radio frequency energy receiver materials linked to this substrate to induce change to the bistable electronic ink; (c) an electronic timer within the device to enable change of the display at intervals before and after the expiration date occurs; (d) an adhesive to enable the device to be attached permanently to any type storage container 22 including but not limited to plastic, metals, and other composites found in reusable storage containers, and/or associated with all packaging of perishable consumer products. The e-addressable display 18 may be sold to manufactures of perishable packaged ingredients or products or sold to users to affix using permanent adhesive on reusable ingredient/product storage containers 22.

The computer and/or program product may enable the user to enter data such as date of expiration and product name specific to an ingredient or product and enable tracking and alerts of data sets 30. A transmitter 16 within the computer 12 updates to the bistable electrically active materials in the e-addressable display 18 with date of expiration information and product name. The transmitter 16 is manufactured with a radio frequency energy that will induce the bistable electrically active ink in e-addressable display 18 only via close proximity to the transmitter 16. The program product may manage a plurality of data sets 30.

The e-addressable display 18 may receive radio frequency energy necessary to properly enable expiration date management and tracking. A computer 12 and program product that works on the computer 12 may capture the inputted data sets 30 and then transmit the data sets 30 via the proper radio frequency energy to the device necessary to change and display the information or is pre-programmed on the e-addressable display 18 for one-time use on packaged perishable ingredients or products. The program product may be adapted to transmit the proper radio frequency energy.

Additional programming of the program product may include a management system to enable high cost perishable use and sharing within enterprises such as a colleges and universities. For example, medical research universities spend a great deal of labor to acquire research grants to purchase high cost perishable reagents (e.g, enzymes or catalyst for molecular biology research) for use in experiments. Because many of these reagents are not always purchased based on volume needs, many partially used perishable reagents sit in laboratories unused and then expire. If these reagents were linked to this system, a software management process could be developed to enable collaborative use across the university among other research labs before the reagents expire thereby reducing the cost of research to other laboratories in the university.

Additional programming of the software could link this system to a lean manufacturing process and reorder system in retail food service establishments, for example, wherein the system would alert the establishment to prepare more perishable product as needed based on customer demand and availability of current just-in-time manufactured product in storage. The system when linked to an enterprise software solution could enable just-in-time reorder of ingredients/products from approved distribution sources to reduce the storage needs before needed to make just-in-time manufactured perishable products. The invention may help consumers reduce food waste in their refrigerators and freezers and alert them to reorder foods via the program product via, for example, text alerts, before they drive home and/or ensure expired pharmaceuticals are not consumed.

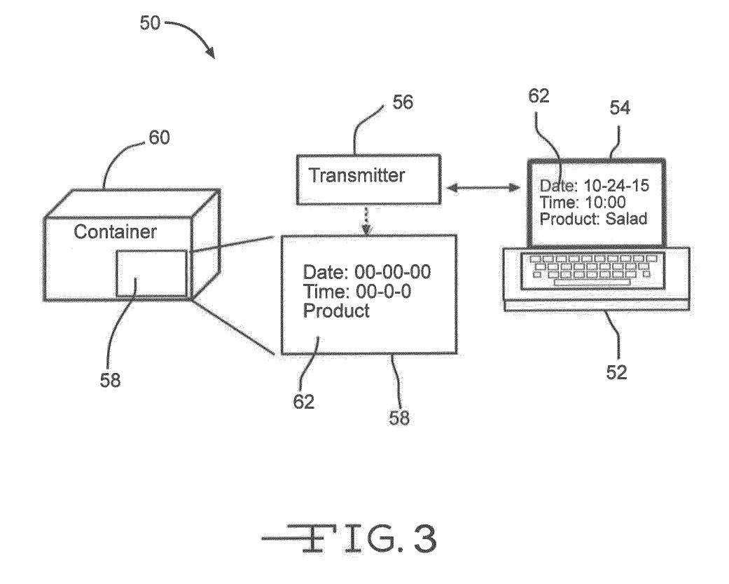

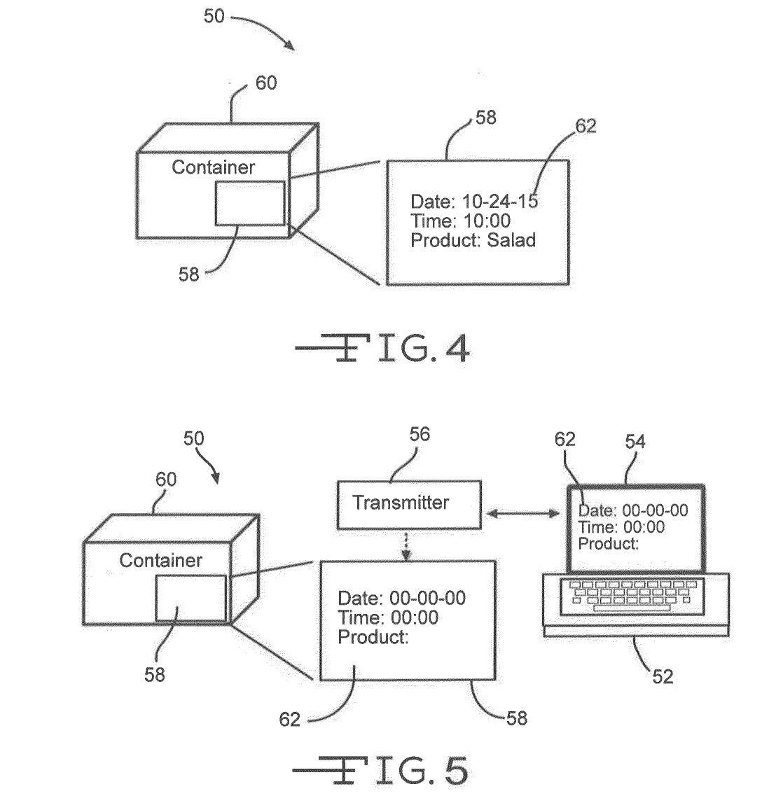

Referring to FIGS. 3-5, the system for managing expiration-dated products of the invention may be the management system 50. As shown in FIG. 3, the management system 50 may have a computer 52 including a user interface 54, a transmitter 56 in communication with the computer 52, and an electronic label such as an e-addressable display 58 in communication with the computer 52 through the transmitter 56. The e-addressable display 58 may be permanently or removably positioned on a container 60, such as one of the containers described above. The computer 52 may have programming including a cloud based software program that allows for communication between the computer 52 and the e-addressable display 58 through the transmitter 56. In this regard, the computer 52 can relay information such as a data set 62 to the e-addressable display 58. For example, the data set 62 may include expiration date information. As shown in FIG. 4, the data set 62 is changed or refreshed on the e-addressable display 58 when the perishable contents of the container 60 are stored. While the cloud based program tracks elapsed time, the program periodically refreshes the e-addressable display 58. Further, the program may notify the user by a text or other type of electronic message with information about remaining time or that the container contents need to be discarded. The e-addressable display 58 may also be refreshed based on a preprogrammed integrated timer at a predetermined time. As shown in FIG. 5, when the perishable contents of the container 60 are consumed or discarded, the data set 62 of the e-addressable display 58 may be refreshed to indicate that that the management system 50 is ready for the next usage.

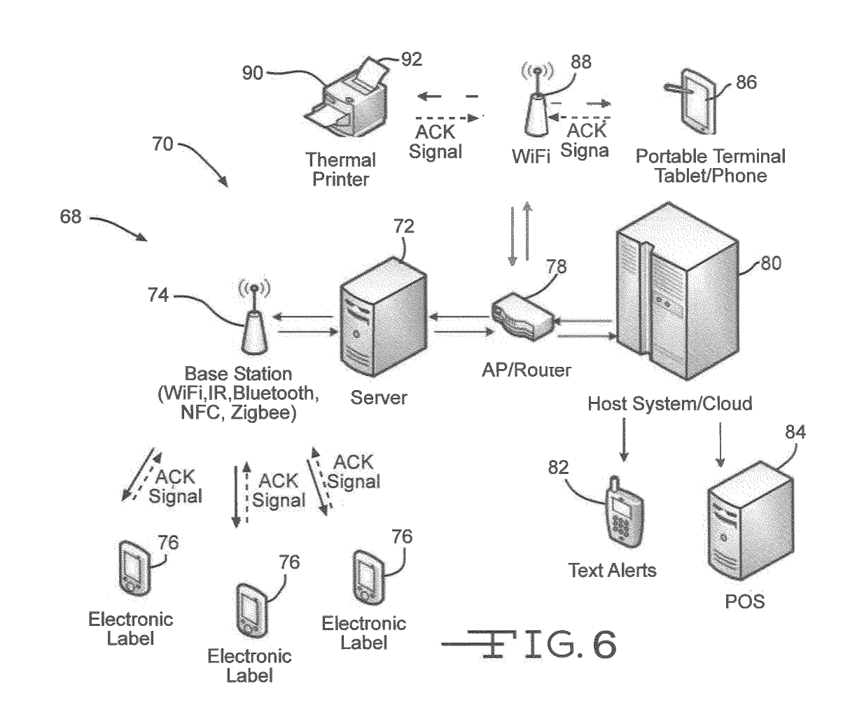

Referring to FIG. 6, the system for managing expiration-dated products of the invention may include a management system 68 that includes an operating system 70. In an embodiment, the operating system 70 may include a server device 72 that is in communication with a base station device 74, which in turn is in communication with one or more electronic labels 76, such as the ones described above. An electronic label 76 may be permanently or removably attached to a container, as described above. The base station device 74 may include, for example, diffused IR, near field communication (NFC), Wi-Fi brand, Bluetooth brand, and ZigBee brand devices and programs. The server device 72 is in communication with an access point (AP)/router device 78 that is in communication with a host system/cloud device 80, which in turn is in communication with a text alerts device 82, such as a smartphone, tablet or similar device. In an embodiment, the text alerts device 82 utilizes a short message service (SMS). In another embodiment, the text alerts device 82 utilizes a multimedia messaging service (MMS). The host system/cloud device 80 may also be in communication with a point of sale (POS) device 84. The server 72 may be in communication with a user terminal device 86 such as a smartphone, tablet or similar device through the AP/router device 78 and an electronic transmission device 88, such as a Wi-Fi brand device. The server 72 may also be in communication with a printer device 90, such as a thermal printer device for printing direct thermal labels 92, through the AP/router device 78 and the electronic transmission device 88. A thermal direct label 92, for example, is permanently or removably applied to a container. The operating system 70 may include acknowledgement (ACK) signals.

Still referring to FIG. 6, the user inputs at least one data set into program of the server 72. For example, information such as date of expiration, product name, ingredients, and use information may be entered. The program may also include a scroll and pick (click on) feature on the user interface so that the user may date mark the information. At the direction of the user, the data set is transmitted through the operating system 70 as shown, for example, in FIG. 6 so that the electronic labels 76 are activated or refreshed to display the information. In an embodiment, the program enables tracking of multiple labels and provides utilities to manage ingredient and/or product use, including alerts to the text alert device 82 directed to, for example, pending product expiration dates of the contents of the containers to which the electronic labels 76 are attached. In an embodiment, the cloud based program of the host system/cloud device 80 tracks elapsed time, and notifies the user by text, such as through the text alert device 82, and/or label refresh, such as through an electronic label 76, that the contents of a container should be discarded. In an embodiment, the electronic label 76 is refreshed by a user selecting a refresh button, which sends a signal so that additional expiration warning texts or other messages are not sent to the user. In an embodiment, the management system 68 allows for dynamic pairing between a cloud-hosted program and one or more electronic labels 76. After the perishable contents of a container to which the electronic label 76 is attached have been consumed or reached their expiration date, the electronic label 76 is refreshed by the user by selecting a refresh button. In an embodiment, the server 72 may be used to print thermal direct labels 92 that include information about the contents of a container.

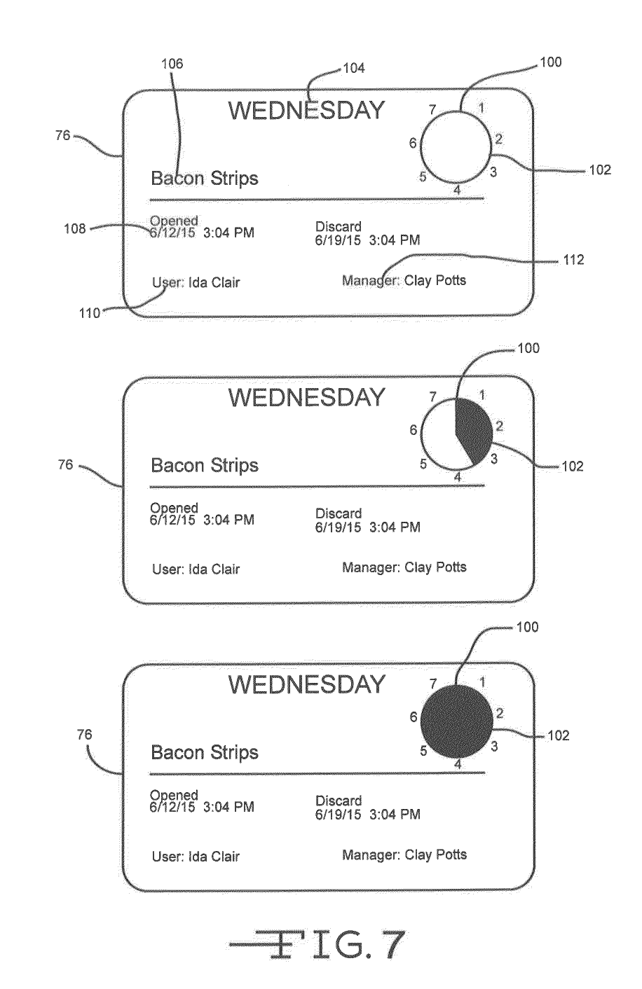

Referring to FIGS. 6 and 7, the electronic label 76 of the management system 68 may include an electronic timer 100 that will induce a preprogrammed change in the electronic label 76 based on the current date and defined expiration date entered while in use on a container. As shown in FIG. 7, the electronic timer 100 may include a clock icon 102. In the top drawing, the clock icon 102 shows no elapsed time. In the middle drawing, the clock icon 102 is revised to show some elapsed time (e.g., 3 days) to indicate that the contents of the container are close to expiration and thus should be used soon. In the bottom drawing, the clock icon 102 with all time elapsed (e.g., 7 days) indicates to the user to stop using the contents of the container. This allows for proper use of the contents of the container and ensures compliance with regulatory requirements. The electronic label 76 may also display, for example, day indicia 104, product indicia 106, date indicia 108, user indicia 110 and manager indicia 112.

Referring to FIG. 8, the electronic label 76 may display, for example, an electronic timer 100, a clock icon 102, day indicia 104, product indicia 106 and date indicia 108. This is useful for situations in which a smaller electronic label 76 is needed.

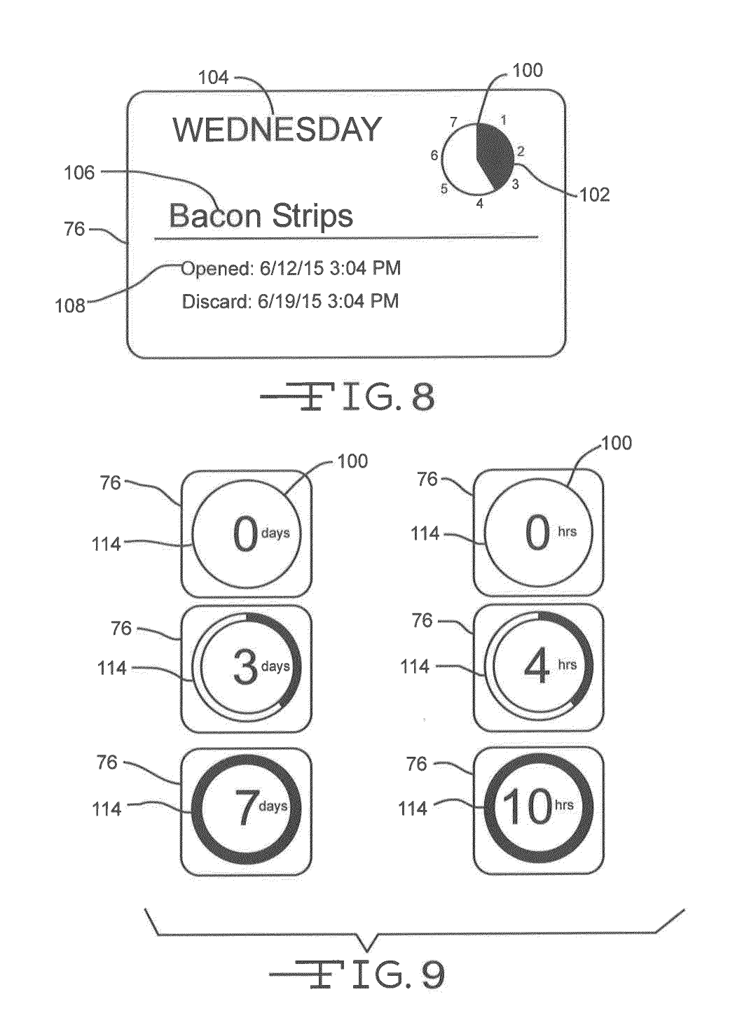

Referring to FIG. 9, the electronic label 76 may display, for example, an electronic timer 100 having an elapsed time indicator 114. As shown in the drawings to the left, the elapsed time indicator 114 can show elapsed time in days, for example, from 0 days, to 3 days, to 7 days. Further, as shown in the drawings to the right, the elapsed time indicator 114 can show elapsed time in hours, for example, from 0 hours, to 4 hours, to 10 hours.

Referring to FIGS. 6-9, the electronic label 76 may be reusable, waterproof, heat/cold resistant, and easy to use. In an embodiment, the electronic label 76 includes a monochrome active matrix display. In another embodiment, the electronic label 76 includes a monochrome segmented display. The electronic label 76 is adapted to function in a temperature range from about 0 to about 180° F. (about −18 to about 183° C.). The size of the electronic label 76 may vary depending on the application. In an embodiment, the electronic label 76 is approximately 2.7 inches (approximately 6.8 cm). In an embodiment, the electronic label 76 is powered by a battery. In an embodiment, the expected battery life is approximately 5 years. In an embodiment, the electronic label 76 may include an adhesive layer, snap, pin, clip and the like to permanently or removably attach the electronic label 76 to a container.

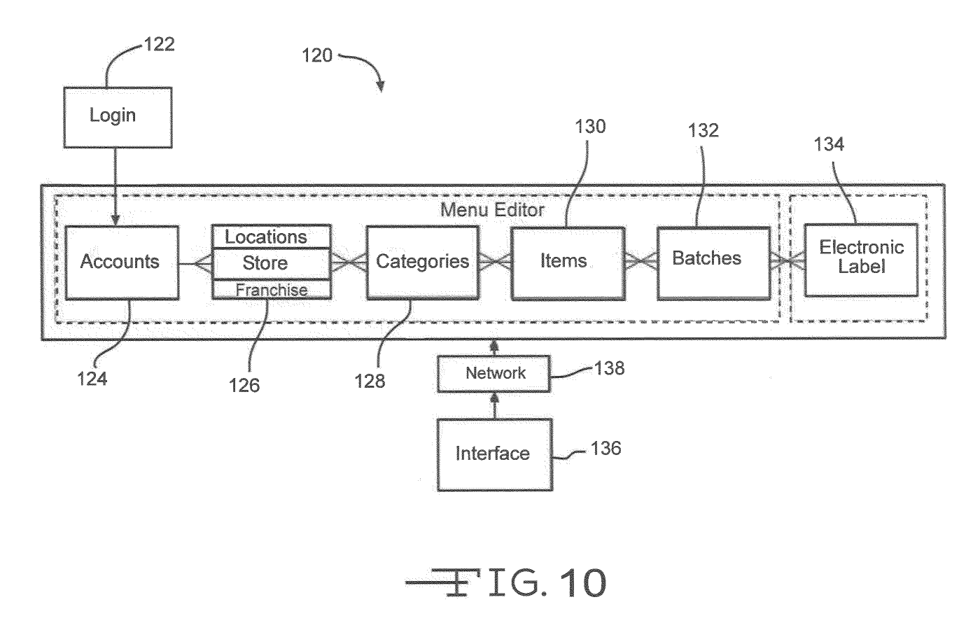

Referring to FIG. 10, the system for managing expiration-dated products of the invention may include a menu editor 120 having a program that allows a user to edit menu data across multiple platforms. In an embodiment, the menu editor 120 is hosted as a web solution and provides for a customer login to allow private administration. In an embodiment, the menu editor 120 uses security sockets layer (SSL) technology, and query string parameters are encrypted. As shown in FIG. 10, the menu editor 120 includes a login feature 122 that is associated with an accounts feature 124. In an embodiment, the login feature 122 is password protected. The accounts feature 124 is the parent entity for a locations feature 126, a categories feature 128, an items feature 130, and a batches feature 132. In an embodiment, the menu editor 120 includes an electronic label feature 134. In an embodiment, the accounts feature is used to organize menu data and assign permissions for logins. In an embodiment, the locations feature 126 is linked to a single account of the accounts feature 124. In an embodiment, the locations feature 126 includes store information and franchise information. In an embodiment, the categories feature 128 is part of the menu data, and allows the user to define or import categories of products and associate them with one or more locations. The categories feature 128 may allow for a category to be in an active or an inactive state. If a category is inactive, all products or items that are associated with that category will be made inactive as well. This allows the user to deactivate seasonal menu categories without the need to delete and re-input those products or items at a later time. In an embodiment, the items feature 130 is part of the menu data. A user may create or import products or items and associate them with one or more locations. Every item is associated with a single category. In an embodiment, the items feature 130 is programmed to allow for assigning locations to an item. In an embodiment, the items feature 130 has an active or inactive state to allow a user to deactivate seasonal menu items, as described above. In an embodiment, the batches feature 132 is programmed to be a collection of items and item quantities. A user will be able to define or import batches information and associate it with one or more locations. Further, a user will be able to define a name for the batch, select items to be part of the batch, and define quantity values for each item of the batch. In an embodiment, the menu editor 120 is in communication with a user interface 136, such as a mobile application interface, through a network 138, such as the Internet. FIG. 10 illustrates a typical hierarchical structure for foodservice. For other applications such as food, chemicals, cosmetics, pharmaceuticals, laboratory reagents, vaccines, etc., an editor with a hierarchical structure is utilized; however, the classification at each level may change. For example, a reagent editor could be used for universities, a medical reagent editor could be used for health care, and a chemical editor could be used for cleaning and sanitation.

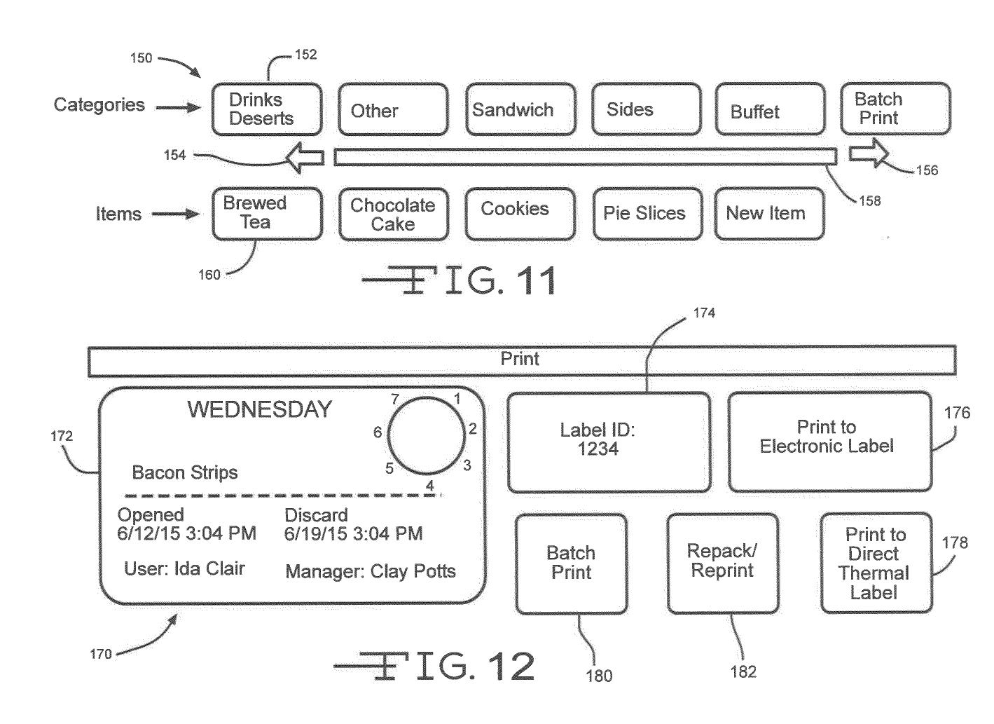

Referring to FIG. 11, the system for managing expiration-dated products of the invention may include a user interface 150 that is programmed to allow a user to access and instruct the system to transmit item information to an electronic container label, such as the electronic label 76, as described above. The user interface 150 can also be used to print a pressure sensitive label, such as the thermal direct label 92, as described above. As shown in FIG. 11, the user interface 150 contains categories and items. To select an item, the user navigates by first selecting the category of that item from the category bar 152. The user selects the arrow keys 154 and 156 to navigate between groups of items. The user can also tap the slider bar 158 to jump to item pages. The user can then select an item from the item bar 160.

Referring to FIG. 12, the system for managing expiration-dated products of the invention may include a print menu 170 that is programmed to appear after an item has been selected from, for example, the user interface 150. In an embodiment, a label preview display 172 of, for example, the electronic label 76 will be shown. The user selects a container with an unused electronic container label and either scans the label or brings the label within range of a reader so as the system automatically recognizes the label and shows such information on a label ID display 174. The user then selects a print to electronic label display 176 to transmit the label image to the electronic label. In an embodiment, the print menu 170 has a print to direct thermal label display 178 to allow a user to print a direct thermal label 92, as described above. In an embodiment, the print menu 170 includes a batch print display 180 to allow for a user to group items together from various categories and print multiple labels at one time. In this regard, each item can be set to print by a defined default amount. In an embodiment, the print menu 170 may include a repack/reprint display 182 to change the expiration start time of the next electronic label 76 for situations when repackaging of product occurs. This allows the user the option to reprint labels with the ability to maintain the correct hold/discard/expiration times.

The computer-based data processing system and method described above is for purposes of example only, and may be implemented in any type of computer system or programming or processing environment, or in a computer program, alone or in conjunction with hardware. The invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the invention have application to a wide range of industries. To the extent this specification discloses a system, the method implemented by that system, as well as software stored on a computer-readable medium and executed as a computer program to perform the method on a general purpose or special purpose computer, are within the scope of the invention. Further, to the extent this specification discloses a method, a system of apparatuses configured to implement the method are within the scope of the invention.

While the invention has been described with reference to particular embodiments, it should be understood that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiments, but that the invention shall include all embodiments falling within the scope of the claims.

We claim:

1. A system for managing expiration-dated products comprising:
a computer;
an electronic label in communication with the computer; and
a program product comprising machine-readable program code for causing, when executed, the computer to transmit a data set containing expiration date information to the electronic label.

2. The system of claim 1, wherein the computer has a user interface.

3. The system of claim 1, wherein the computer is selected from the group consisting of a desktop, a laptop and a smart device.

4. The system of claim 1, wherein the electronic label has a display for displaying text of the data set.

5. The system of claim 1, wherein the electronic label has a display for displaying a number of the data set.

6. The system of claim 1, wherein the electronic label has a display for displaying an image of the data set.

7. The system of claim 1, wherein the electronic label has a display for displaying colors of the data set selected from the group consisting of red, yellow, green, black and white.

8. The system of claim 1, wherein the electronic label has a display for displaying a clock icon of the data set.

9. The system of claim 1, wherein the system includes a container for containing expiration-dated products, the electronic label being adapted for attachment to the container.

10. The system of claim 1, wherein the computer is in communication with a network of one or more additional computers.

11. The system of claim 1, wherein the computer is in communication with the Internet.

12. The system of claim 1, wherein the computer is in communication with a cloud network.

13. The system of claim 1, wherein the computer is in communication with a cloud network for providing dynamic pairing with the electronic label.

14. The system of claim 1, wherein the computer is in communication with a text alerts device to provide notifications about the data set.

15. The system of claim 1, wherein the computer is in communication with a printer for printing labels containing expiration date information.

16. The system of claim 1, wherein the program product has a menu editor.

17. The system of claim 16, wherein the menu editor has features selected from the group consisting of accounts, locations, categories, items and batches.

18. The system of claim 1, wherein the program product has a user interface for the selection of categories of items and specific items.

19. The system of claim 1, wherein the program product has a print menu.

20. The system of claim 19, wherein the print menu has features selected from the group consisting of a label preview display, a label ID display, a print to electronic label display, a print to direct thermal label display, a batch print display and a repack/reprint display.

21. The system of claim 19, wherein the program product allows for the recognition of the electronic label and displays information about the electronic label on the print menu.

22. The system of claim 1, wherein the electronic label includes an autonomous battery.
